(19) United States
(12) Patent Application Publication
(10) Pub. No.: US 2026/0084699 A1
(43) Pub. Date: Mar. 26, 2026

(54) TRAVEL CONTROL APPARATUS, TRAVEL CONTROL METHOD, TRAVEL CONTROL PROGRAM, AND STORAGE MEDIUM

(71) Applicants: DENSO CORPORATION, Kariya-city (JP); J-QUAD DYNAMICS INC., Tokyo (JP)

(72) Inventors: Yutaro ITO, Kariya-city (JP); Shigenori ICHINOSE, Tokyo (JP); Tatsumi SUGIYAMA, Tokyo (JP)

(73) Assignees: DENSO CORPORATION, Kariya-city (JP); J-QUAD DYNAMICS INC., Tokyo (JP)

(21) Appl. No.: 19/332,210

(22) Filed: Sep. 18, 2025

(30) Foreign Application Priority Data
Sep. 20, 2024 (JP) 2024-164190

(51) Int. Cl. B60W 30/18

(52) U.S. Cl. CPC B60W 30/18159; B60W 2520/10; B60W 2554/4041; B60W 2555/60

(57) ABSTRACT

In a travel control apparatus, a frontal information acquisition unit acquires frontal information including a display cycle of one or more traffic lights ahead of the vehicle. A travel plan generation unit generates a passing travel plan in which the vehicle passes through the traffic light without needing to wait for the traffic light to change. A travel plan determination unit determines that travel control of the vehicle is performed using a stopping travel plan in which the vehicle is stopped to wait for the traffic light to change, instead of the passing travel plan, in response to vehicle speed control information included in the generated passing travel plan including a predetermined stopping travel recommendation condition. The stopping travel recommendation condition includes a vehicle speed equal to or less than a threshold vehicle speed continuing for a predetermined period of time or longer, or deceleration exceeding a deceleration threshold.

### CROSS-REFERENCE TO RELATED APPLICATIONS

This application is based on and claims the benefit of priority from Japanese Patent Application No. 2024-164190, filed on Sep. 20, 2024. The entire disclosure of the above application is incorporated herein by reference.

### BACKGROUND

The present disclosure relates to a travel control apparatus for a vehicle.

A technology is known in which a signal including information on a position and a color change parameter of a traffic light set in an advancing direction of a vehicle is received. The received signal is processed to ascertain a period of time over which the traffic light is green. A range of speed allowing the vehicle to pass through each traffic light is then calculated.

### SUMMARY

An aspect of the present disclosure provides a travel control apparatus for a vehicle, the travel control apparatus including at least one of (i) a circuit and (ii) a processor with a memory storing computer program code executable by the processor, the at least one of the circuit and the processor configured to implement: a frontal information acquisition unit that acquires frontal information including a display cycle of one or more traffic lights ahead of the vehicle; a travel plan generation unit that generates a passing travel plan in which the vehicle passes through the traffic light without needing to wait for the traffic light to change, based on the acquired frontal information; and a travel plan determination unit that determines that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, in which the stopping travel recommendation condition includes a vehicle speed equal to or less than a threshold vehicle speed continuing for a predetermined period of time or longer, or deceleration exceeding a deceleration threshold.

### BRIEF DESCRIPTION OF THE DRAWINGS

In the accompanying drawings:

FIG. 1 is a schematic diagram illustrating a traveling state of a vehicle to which the present disclosure is applicable;

FIG. 2 is a block diagram illustrating an overall apparatus configuration of an in-vehicle system shown in FIG. 1;

FIG. 3 is a block diagram illustrating an overall functional configuration actualized by a travel control apparatus shown in FIG. 2 running a travel control program;

FIG. 4 is a graph for explaining factors affecting a psychological state of an occupant in green-wave travel control;

FIG. 5 is a graph for explaining an overview of vehicle travel control of the present disclosure;

FIG. 6 is a graph for explaining an overview of an example of vehicle travel control of the present disclosure;

FIG. 7 is a graph for explaining an energy-efficiency improvement effect of a vehicle speed control pattern shown in FIG. 6;

FIG. 8 is a graph for explaining an overview of another example of vehicle travel control of the present disclosure;

FIG. 9 is a graph for explaining the energy-efficiency improvement effect of a vehicle speed control pattern shown in FIG. 8;

FIG. 10 is a flowchart illustrating an overview of an operational example of a travel control apparatus according to an embodiment of the present disclosure;

FIG. 11 is a flowchart illustrating an overview of the operational example of the travel control apparatus according to the embodiment of the present disclosure; and

FIG. 12 is a flowchart illustrating an overview of the operational example of the travel control apparatus according to the embodiment of the present disclosure.

### DESCRIPTION OF THE EMBODIMENTS

Embodiments of the present disclosure relates to a travel control apparatus for a vehicle, a travel control method, a travel control program, and a non-transitory computer-readable storage medium on which the travel control program is stored.

In a technology described in JP 3235136 B2, a signal including information on a position and a color change parameter of a traffic light set in an advancing direction of a vehicle is received. The received signal is processed to ascertain a period of time over which the traffic light is green. A range of speed allowing the vehicle to pass through each traffic light is then calculated. If this range of speed is maintained, a number of times the vehicle starts and stops is reduced. Therefore, the vehicle can travel with less fuel consumption and less exhaust gas emission.

For example, in this type of technology, an occupant of the vehicle may experience unease or discomfort due to deceleration, extended periods of low-speed travel, and the like when the vehicle travels within the calculated range of speed. However, if this technology is disabled due to such unease and discomfort experienced by the occupant, energy saving effects and environmental performance of this technology cannot be achieved

It is thus desired to provide, for example, a technology that enables desired energy saving effects and environmental performance to be achieved while favorably suppressing unease and discomfort experienced by a vehicle occupant.

A first exemplary embodiment of the present disclosure provides a travel control apparatus for a vehicle. the travel control apparatus including: a frontal information acquisition unit that acquires frontal information including a display cycle of one or more traffic lights ahead of the vehicle; a travel plan generation unit that generates a passing travel plan in which the vehicle passes through the traffic light without needing to wait for the traffic light to change, based on the acquired frontal information; and a travel plan determination unit that determines that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, in which the stopping travel recommendation condition includes a vehicle speed equal to or less than a threshold vehicle speed continuing for a predetermined period of time or longer, or deceleration exceeding a deceleration threshold.

A second exemplary embodiment of the present disclosure provides a travel control method for a vehicle, the travel control method including: acquiring frontal information including a display cycle of one or more traffic lights ahead of the vehicle; generating a passing travel plan in which the vehicle passes through the traffic light without needing to wait for the traffic light to change, based on the acquired frontal information; and determining that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, in which the stopping travel recommendation condition includes a vehicle speed equal to or less than a threshold vehicle speed continuing for a predetermined period of time or longer, or deceleration exceeding a deceleration threshold.

A third exemplary embodiment of the present disclosure provides a travel control program executed by a travel control apparatus for a vehicle, the travel control program causing the travel control apparatus to perform processes including: a process for acquiring frontal information including a display cycle of one or more traffic lights ahead of the vehicle; a process for generating a passing travel plan in which the vehicle passes through the traffic light without needing to wait for the traffic light to change, based on the acquired frontal information; a process for determining that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, in which the stopping travel recommendation condition includes a vehicle speed equal to or less than a threshold vehicle speed continuing for a predetermined period of time or longer, or deceleration exceeding a deceleration threshold.

A fourth exemplary embodiment of the present disclosure provides a non-transitory computer-readable storage medium storing therein a travel control program executed by a travel control apparatus for a vehicle, the travel control program causing the travel control apparatus to perform processes including: a process for acquiring frontal information including a display cycle of one or more traffic lights ahead of the vehicle; a process for generating a passing travel plan in which the vehicle passes through the traffic light without needing to wait for the traffic light to change, based on the acquired frontal information; a process for determining that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, in which the stopping travel recommendation condition includes a vehicle speed equal to or less than a threshold vehicle speed continuing for a predetermined period of time or longer, or deceleration exceeding a deceleration threshold.

Here, elements may be given reference numbers in parentheses in each section of the application documents. However, the reference numbers merely indicate examples of corresponding relationships between the elements and specific means described according to the embodiments described hereafter. Therefore, the present disclosure is not limited in any way by the reference numbers described above.

### EMBODIMENTS

Exemplary embodiments or specific examples of the present disclosure will hereinafter be described with reference to the drawings as appropriate. Here, the embodiment and modifications thereof, as well as descriptions in related drawings below are schematic or simplified to concisely explain the contents of the present disclosure, and are not intended to limit the contents of the present disclosure in any way. Therefore, it goes without saying that the descriptions in the drawings do not necessarily match specific apparatus configurations that are actually manufactured and sold. In other words, it goes without saying that the present disclosure should not be interpreted in a limited manner by the descriptions in the drawings, and the corresponding descriptions of apparatus configurations and functions or operations thereof, described below, unless explicitly limited by the applicant through the prosecution history of the present application.

(Overview of an in-Vehicle System)

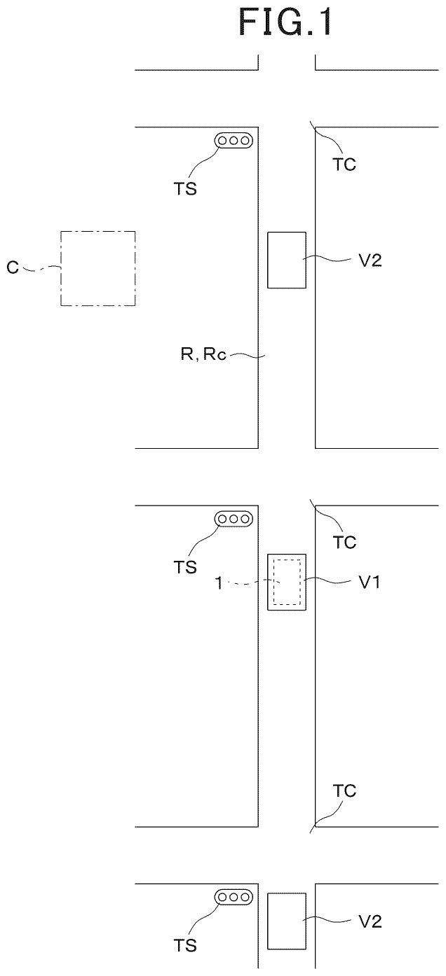

First, with reference to FIG. 1, an in-vehicle system 1 is mounted in an own vehicle V1 and is thereby configured to perform various operations including travel control of the own vehicle V1. Specifically, the in-vehicle system 1 has a configuration as a driving automation system. The driving automation system is an autonomous driving system, a driving assistance system, or both.

That is, the in-vehicle system 1 is configured to be capable of actualizing a driving automation level corresponding to at least one of levels 1 to 5 prescribed by the standard “SAE J3016” published by SAE International. SAE is an abbreviation of Society Of Automotive Engineers. Level X in “SAE J3016” will be referred to hereafter simply as “SAE Level X.” X is any of 0 to 5. SAE Level 0 is referred to as manual operation. SAE Level 1 is referred to as driving assistance. SAE Level 2 is referred to as advanced driving assistance. SAE Level 3 is referred to as conditional autonomous driving. SAE Level 4 is referred to as advanced autonomous driving. SAE Level 5 is referred to as fully autonomous driving.

According to the present embodiment, the in-vehicle system 1 is configured to be capable of continuously performing, of a vertical-direction vehicle-movement control subtask and a lateral-direction vehicle-movement control subtask included in dynamic driving tasks, at least the vertical-direction vehicle-movement control subtask. The vertical-direction vehicle-movement control subtask is starting, accelerating/decelerating, and stopping. The lateral-direction vehicle-movement control subtask is steering. The “dynamic driving tasks” are all operational and tactical functions required to be performed in real time when the own vehicle V1 is operated in road traffic, and exclude strategic functions. Overall driving behavior can be categorized into three functions: strategic, tactical, and operational. The “strategic” functions include itinerary planning, route selection, and the like. Specifically, the strategic functions include deciding and selecting itinerary plans such as “whether to go, and when, where, and how to go.” The “tactical” functions involve vehicle operation in traffic situations, such as deciding whether and when to overtake a vehicle or change lanes, choosing an appropriate speed, checking mirrors, and the like. The “operational” functions involve instantaneous reactions such as making small corrections to steering, braking, and operation of an accelerator and acceleration to maintain a position in a traffic lane on a road or to avoid unexpected obstacles and hazardous events on the road ahead of the vehicle.

More specifically, the in-vehicle system 1 according to the present embodiment is configured to be capable of performing so-called green-wave travel control. Green-wave travel refers to adjusting a vehicle speed to allow a vehicle to pass through one or more traffic lights TS on a green light without needing to wait for the light to change. Green-wave travel is typically used to allow the own vehicle V1 to pass through a road section Rc in which a plurality of traffic lights TS are set on a road R on which the own vehicle V1 is currently traveling, without waiting for any of the traffic lights to change. Hereafter, the road section Rc serving as a green-wave travel-control section for the own vehicle V1 is assumed to include a predetermined number of traffic lights TS or intersections TC on the road R as targets for green-wave travel. Here, it goes without saying that the traffic light TS is not only set at the intersection TC. In addition, in cases in which an expected travel path of the own vehicle V1 includes a left or right turn at the intersection TC, the road section Rc serving as the green-wave travel-control section also includes the intersection TC at which the left or right turn is to be performed.

Green-wave travel can be applied not only to the own vehicle V1 traveling alone, but also to a group of vehicles including other vehicles V2 in front of and behind the own vehicle V1 traveling in a platoon. Therefore, the in-vehicle system 1 according to the present embodiment is configured to be capable of green-wave travel while traveling in a platoon by acquiring traffic light information and travel information of the other vehicles V2, through V2V communication with the other vehicles V2 and V2I communication with an external apparatus C. V2V stands for Vehicle-to-Vehicle and can also be referred to as “vehicle-to-vehicle communication.” V2I stands for Vehicle-to-roadside-Infrastructure and is also referred to as “vehicle-to-roadside communication.” A concept that encompasses both V2V and V2I is referred to as V2X. V2X stands for vehicle-to-any or Vehicle-to-X.

(Configuration of the in-Vehicle System)

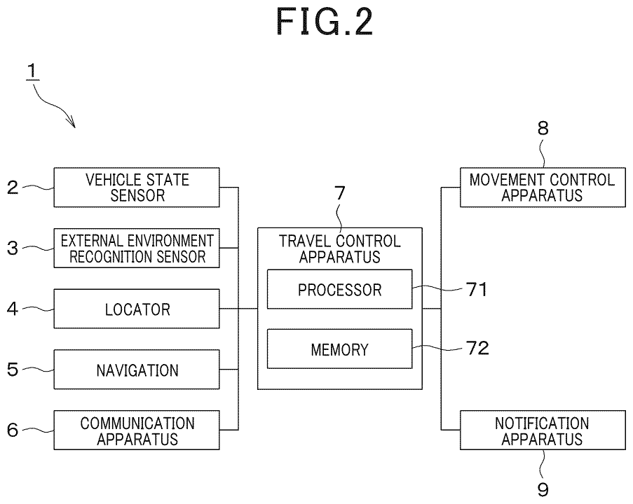

With reference to FIG. 2, the in-vehicle system 1 includes a vehicle state sensor 2, an external environment recognition sensor 3, a locator 4, a navigation apparatus 5, a communication apparatus 6, a travel control apparatus 7, a movement control apparatus 8, and a notification apparatus 9. The vehicle state sensor 2, the external environment recognition sensor 3, the locator 4, the navigation apparatus 5, the communication apparatus 6, the travel control apparatus 7, the movement control apparatus 8, and the notification apparatus 9 are connected to be capable of transmitting and receiving information or signals over an in-vehicle network. The in-vehicle network is configured to comply with a predetermined communication standard such as CAN (international registered trademark: International Registration Number 1048262A). CAN (international registered trademark) is an acronym for Controller Area Network. In addition to a main network complying with CAN (international registered trademark), the in-vehicle network may have separate main network or a sub-network complying with LIN, FlexRay, or the like. LIN is an abbreviation of Local Interconnect Network.

The vehicle state sensor 2 is provided to detect various quantities related to a driving state of the own vehicle V1. The “driving state” includes a driving operation state and a driving behavior state of the own vehicle V1. The “driving operation state” refers to a state of driving operation input to the own vehicle V1 performed by a driver of the own vehicle V1 or the travel control apparatus 7. For example, the driving operation state may include a steering amount, a throttle opening, a brake operation amount, a shift range, and the like. The “driving behavior state” refers to a state related to movement or behavior of the own vehicle V1. For example, the driving behavior state may include a vehicle speed, acceleration, a yaw rate, and the like. In addition, the vehicle state sensor 2 is provided to detect, for example, brightness, an amount of rain, and outside air temperature that are aspects of a travel environment of the own vehicle V1 differing from those detected or sensed by the external environment recognition sensor 3. That is, the vehicle state sensor 2 is a collective term for various types of sensors, such as an accelerator opening sensor, a brake pedal sensor, a vehicle speed sensor, a yaw rate sensor, a raindrop sensor, and an outside air temperature sensor.

The external environment recognition sensor 3 is provided to recognize external environment information of the own vehicle V1 or, in other words, aspects of the travel environment on the road R differing from those detected or sensed by the vehicle state sensor 2. That is, the external environment recognition sensor 3 is provided to recognize a state in which a target is present. The “target” includes not only three-dimensional “objects” such as other vehicles V2, pedestrians, and obstacles, but also two-dimensional displays such as road markings. Specifically, a device such as a camera, a millimeter wave radar, or a LiDAR is provided as the external environment recognition sensor 3. LiDAR is an acronym for Light Detection and Ranging or Laser Imaging Detection and Ranging. The external environment recognition sensor 3 is also referred to as an ADAS sensor. ADAS is an abbreviation of Advanced Driver-Assistance Systems.

The locator 4 is configured to measure a position of the own vehicle V1. Specifically, the locator 4 provides at least a satellite positioning function to measure the position of the own vehicle V1 by receiving a positioning signal transmitted from a positioning satellite. Here, the locator 4 may be configured to also provide an autonomous positioning function using an inertial sensor such as a gyro sensor or an acceleration sensor, to improve measurement accuracy of the position of the own vehicle V1 in a location where satellite radio waves are difficult to reach, such as inside a tunnel. The inertial sensor may be provided in the locator 4 or may be included in the vehicle state sensor 2. As the locator 4 including the inertial sensor, for example, a positioning and orientation system for land vehicles “POSLV,” manufactured by Applanix Corporation, is commercially available.

The locator 4 further includes a map database. The map database is mainly configured by a large-capacity, non-volatile storage medium storing therein large amounts of three-dimensional map data and two-dimensional map data. The three-dimensional map data is so-called high-precision map data, and includes information required for advanced driving assistance and autonomous driving, such as three-dimensional shape information of the road R and detailed information on each traffic lane. The high-precision map data is also referred to as HD map data. HD is an abbreviation of High Definition.

The navigation apparatus 5 is provided to acquire an expected travel path from a current position of the own vehicle V1 to a predetermined destination. According to the present embodiment, the navigation apparatus 5 is configured to calculate the expected travel path based on a destination set by the driver of the own vehicle V1 or the like, the high-precision map information acquired from the locator 4, and the position information and direction information of the own vehicle V1 acquired from the locator 4.

The communication apparatus 6 is an in-vehicle communication module, and is provided to be capable of performing wireless communication with the external apparatus C and other vehicles V2. Here, as the communication apparatus 6, a communication module for V2V and a communication module for V2I that are differing systems may be provided separately.

The travel control apparatus 7 is configured to perform driving automation operations in the own vehicle V1 based on various types of information, signals, and the like acquired from the vehicle state sensor 2, the external environment recognition sensor 3, the locator 4, the navigation apparatus 5, and the communication apparatus 6. That is, the travel control apparatus 7 has a configuration as a so-called driving assistance ECU or an autonomous driving ECU. ECU is an abbreviation of Electronic Control Unit.

According to the present embodiment, the travel control apparatus 7 is configured as an in-vehicle microcomputer including at least a processor 71 and a memory 72. The processor 71 includes at least a single calculation unit that functions or is configured as a central processing unit (CPU) or a microprocessor unit (MPU), and peripheral circuits (such as a timer circuit) thereof. The memory 72 includes at least a random access memory (RAM), a read-only memory (ROM), or a non-volatile rewritable memory, among various types of non-transitory, tangible storage media such as the ROM, the RAM, and the non-volatile rewritable memory. The non-volatile rewritable memory is a storage apparatus that allows information to be rewritten while power is turned on but retains information in a non-rewritable manner while power is interrupted. For example, the non-volatile rewritable memory may be a flash memory.

The travel control apparatus 7 is configured to actualize a predetermined function to actualize the driving automation operations in the own vehicle V1 by the processor 71 reading and running a computer program from the memory 72. The memory 72 stores therein the above-described computer program as well as various types of data such as initial values, maps, and look-up tables required to run the computer program. Details of a functional configuration actualized by the travel control apparatus 7 through execution of a travel control method or a travel control program of the present disclosure will be described hereafter.

The movement control apparatus 8 is provided to perform vehicle movement control such as starting, accelerating/decelerating, braking, stopping, and steering of the own vehicle V1. That is, the own vehicle V1 includes a power generation mechanism, a power transmission mechanism, a braking mechanism, a steering mechanism, ECUs for controlling operations of these mechanisms, and the like as the movement control apparatus 8. Here, as the power generation mechanism, at least either of a motor and an engine may be provided.

The notification apparatus 9 is provided to notify the occupant of the own vehicle V1, such as the driver, of various types of information. That is, the own vehicle V1 includes an information display apparatus. such as an instrument panel or a head-up display apparatus, an audio output apparatus, or the like as the notification apparatus 9.

### (Travel Control Apparatus)

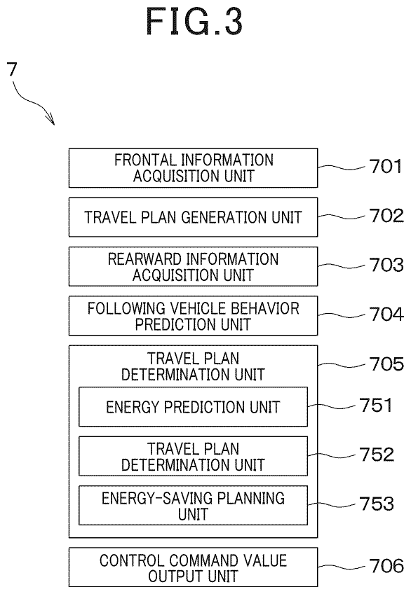

According to the present embodiment, the travel control apparatus 7 has a functional configuration shown in FIG. 3 as a configuration for actualizing green-wave travel by autonomous vehicle speed control rather than driving operations by the driver. That is, each functional block shown in FIG. 3 is a functional configuration actualized by the processor 71 running a computer program corresponding to the travel control program of the present disclosure.

The functional configuration of the travel control apparatus 7 according to the present embodiment will be described below with reference to FIG. 3, in addition to FIG. 1 and FIG. 2. Specifically, as the functional configuration, the travel control apparatus 7 has a frontal information acquisition unit 701, a travel plan generation unit 702, a rearward information acquisition unit 703, a following vehicle behavior prediction unit 704, a travel plan determination unit 705, and a control command value output unit 706.

The frontal information acquisition unit 701 acquires frontal information including a lighting state and a display cycle of one or more (that is, typically a plurality of) traffic lights TS arranged ahead of the own vehicle V1. The “frontal information” includes dynamic information and static information. For example, the dynamic information may include travel information of the other vehicle V2 that is a preceding vehicle, in addition to traffic light information such as the display cycle, described above. For example, the travel information can be acquired based on detection results of frontal targets from the external environment recognition sensor 3 and information received through V2X communication using the communication apparatus 6.

In particular, according to the present embodiment, the frontal information includes a travel plan of the preceding vehicle for platoon travel control. The travel plan includes an expected travel path, vehicle speed control information, and the like. Platoon travel control refers to control performed such that, in a case in which the own vehicle V1 and other vehicles V2 in front of and behind the own vehicle V1 form a single vehicle group, the vehicles included in the vehicle group behave in a substantially identical manner. The vehicle speed control information includes a vehicle speed pattern for vehicle speed control.

For example, the static information may include information acquired from map information, such as a road gradient and a turning curvature ahead of the own vehicle V1. Here, the turning curvature is not limited to curved roads. That is, for example, in a case in which the road section Rc serving as the green-wave travel-control section also includes the intersection TC at which the own vehicle V1 is expected to turn left or right, the turning curvature also includes a curvature of a travel trajectory for the left or right turn at the intersection TC.

The travel plan generation unit 702 generates a travel plan for the own vehicle V1 in the road section Rc based on the frontal information acquired by the frontal information acquisition unit 701. The travel plan includes a passing travel plan and a stopping travel plan. The passing travel plan is a travel plan for green-wave travel control. The passing travel plan allows the own vehicle V1 to pass through one or more (that is, such as a plurality of) traffic lights TS or the road section Rc including the traffic lights TS without needing to wait for the light to change. The stopping travel plan is a travel plan in a case in which the green-wave travel control is not performed. In the stopping travel plan, the own vehicle V1 stops at the traffic light TS to wait for the light to change, as required.

According to the present embodiment, the travel plan generation unit 702 generates a plurality of travel plans based on a predetermined generation condition. For example, the generation condition may include upper limit values for acceleration and deceleration, upper and lower limit values for speed, an upper limit value for deviation from a current vehicle speed, and a degree of use of an energy-saving travel means (such as coasting or engine braking). Specifically, the travel plan generation unit 702 generates a plurality of passing travel plans with differing vehicle speed patterns and degrees of energy saving, and a plurality of stopping travel plans with differing vehicle speed patterns and degrees of energy saving. That is, the travel plan generation unit 702 generates a plurality of travel plans weighted differently for occupant comfort and energy efficiency.

The rearward information acquisition unit 703 acquires rearward information including presence/absence of the other vehicle V2 serving as a following vehicle that travels behind the own vehicle V1 so as to follow the own vehicle V1. The “rearward information” includes the presence/absence, an inter-vehicle distance, and behavior (that is, acceleration/deceleration state and the like) of the following vehicle. Specifically, the rearward information acquisition unit 703 acquires the rearward information based on detection results of rearward targets from the external environment recognition sensor 3, information received through V2X communication using the communication apparatus 6, and the like.

The following vehicle behavior prediction unit 704 predicts the behavior of the following vehicle based on the travel plan of the own vehicle V1 generated by the travel plan generation unit 702 and the rearward information acquired by the rearward information acquisition unit 703. The prediction of behavior can be made using various methods proposed as vehicle-following models, such as a Gipps' model and an Intelligent Driver Model.

The travel plan determination unit 705 determines a final travel plan to be used to actually perform travel control of the own vehicle V1 based on the travel plans generated by the travel plan generation unit 702. Specifically, the travel plan determination unit 705 has an energy prediction unit 751, a travel plan determination unit 752, and an energy-saving planning unit 753.

The energy prediction unit 751 calculates energy consumption of the own vehicle V1 and the other vehicle V2 forming the same vehicle group with the own vehicle V1 based on the travel plans and the behavior prediction results of the own vehicle V1 and the other vehicle V2. An example of a method for calculating energy consumption will be briefly described below.

Required drive force F is determined as in expression (1), below. In expression (1), M denotes vehicle weight, α denotes acceleration, ρ denotes air density, A denotes total projected area, C_{d} denotes air resistance coefficient, μᵣ denotes rolling resistance coefficient, g denotes gravitational acceleration, and θ denotes gradient. That is, on a right side of expression (1), a first term relates to acceleration, a second term relates to air resistance, a third term relates to rolling resistance, and a fourth term relates to gradient resistance.

$$F = M α + \frac{1}{2} ρ {AC}_{d} {V}^{2} + {μ}_{γ} Mg + Mg sin θ \qquad ( 1 )$$

Here, by ignoring changes in air resistance and rolling resistance as being minute, and obtaining the values in unit of acceleration by dividing by the vehicle weight to eliminate influence of individual differences between vehicles, expression (1) can be simplified to expression (2), below.

$$F ≅ α + g sin θ \qquad ( 2 )$$

From this, power P can be determined by expression (3), below. Then, by time integration being performed as in expression (4), below, energy consumption can be estimated.

$$P = FV \qquad ( 3 )$$

$$E = {\int }_{0}^{T} Pdt \qquad ( 4 )$$

The travel plan determination unit 752 determines that travel control of the own vehicle V1 is performed using the stopping travel plan instead of the passing travel plan when the vehicle speed control information included in the passing travel plan generated by the travel plan generation unit 702 includes a predetermined stopping travel recommendation condition. Here, the predetermined stopping travel recommendation condition includes the vehicle speed control information, that is, the vehicle speed pattern causing the occupant, such as the driver, of the own vehicle V1 to experience unease or discomfort when the green-wave travel control is performed using the passing travel plan. Specifically, for example, the stopping travel recommendation condition may include a vehicle speed that is equal to or lower than a threshold vehicle speed continuing for a predetermined period of time or longer, or deceleration exceeding a deceleration threshold.

The energy-saving planning unit 753 determines final vehicle speed control information from a perspective of improving energy efficiency, based on the vehicle speed control information included in the passing travel plan or the stopping travel plan. Specifically, the energy-saving planning unit 753 determines the vehicle speed control information included in the stopping travel plan from a perspective of improving energy efficiency when the own vehicle V1 decelerates and stops to wait for the light to change. More specifically, the energy-saving planning unit 753 determines the vehicle speed control information such that, instead of friction braking, regenerative braking and, if necessary, coasting or engine braking are used when the own vehicle V1 decelerates and stops to wait for the light to change in the stopping travel plan.

According to the present embodiment, the energy-saving planning unit 753 determines a final travel plan to be used to actually perform travel control of the own vehicle V1 by selecting a most energy efficient travel plan among the plurality of travel plans generated by the travel plan generation unit 702. Specifically, if at least one of the plurality of passing travel plans are unlikely to cause the occupant unease or discomfort, that is, not include the stopping travel recommendation condition, the energy-saving planning unit 753 selects the most energy efficient passing travel plan among the passing travel plans. In addition, if all of the plurality of passing travel plans are likely to cause the occupant unease or discomfort, that is, include the stopping travel recommendation condition, the energy-saving planning unit 753 selects the most energy efficient stopping travel plan among the stopping travel plans.

Furthermore, the energy-saving planning unit 753 derives a control parameter included in the vehicle speed control information corresponding to the final travel plan used to actually perform travel control of the own vehicle V1. For example, the control parameter may include all or some of speed, acceleration/deceleration, drive force, and braking force.

According to the present embodiment, the energy-saving planning unit 753 determines the vehicle speed control information that maximizes energy efficiency in the vehicle group including the own vehicle V1 and the other vehicle V2. Specifically, the energy-saving planning unit 753 derives the control parameter as a solution that satisfies expression (5), below, taking into consideration energy consumption of an N number of vehicles including the own vehicle V1. In expression (5), p denotes the control parameter.

$$min ( {\sum }_{i = 1}^{N} {E}_{i} ( p ) ) \qquad ( 5 )$$

The control command value output unit 706 outputs the control parameter derived by the energy-saving planning unit 753 to the movement control apparatus 8. The movement control apparatus 8 is configured to perform behavior control of the own vehicle V1 based on the control parameter received from the travel control apparatus 7.

### (Operation Overview)

An overview of the operation of the travel control apparatus 7 according to the present embodiment will be described below, in addition to effects achieved by the travel control apparatus 7, and the travel control method and travel control program executed thereby. In the description below, the travel control apparatus 7 according to the present embodiment, the travel control method and travel control program executed thereby, and the non-transitory computer-readable storage medium on which the program is stored may be collectively referred to simply as “the present embodiment.”

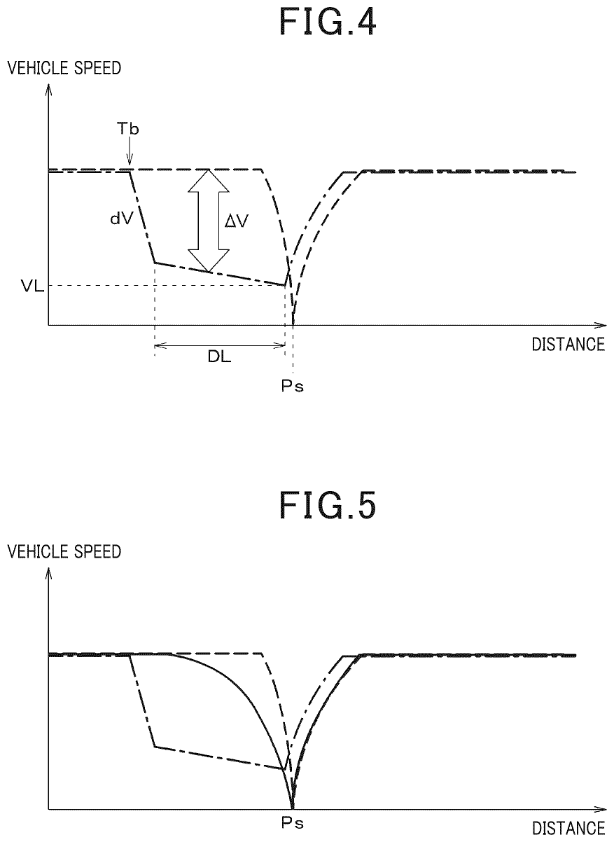

FIG. 4 shows an example of a vehicle speed pattern before and after a traffic light position Ps that is a position at which a certain traffic light TS is present. In FIG. 4, a single-dot chain line shows the vehicle speed pattern in a case in which the own vehicle V1 passes through the traffic light position Ps without stopping by green-wave travel control. Meanwhile, a broken line shows the vehicle speed pattern in a case in which green-wave travel control is not performed and the own vehicle V1 stops at the traffic light position Ps to wait for the light to change. This similarly applies to FIG. 5 and subsequent drawings.

With reference to FIG. 4, factors that affect a degree of unease or discomfort experienced by the occupant when green-wave travel control is performed may include, for example, a deceleration start timing Tb, a maximum deceleration dV, a minimum travel speed VL, a duration of low-speed range DL, and speed deviation ΔV. The maximum deceleration dV is a maximum value of deceleration in the vehicle speed pattern. The minimum travel speed VL is a minimum value of the vehicle speed while green-wave travel control is being performed. The duration of low-speed range DL is a low-speed travel time, that is, a duration over which the own vehicle V1 travels at a vehicle speed close to the minimum travel speed VL. The speed deviation ΔV is a difference in vehicle speed between when green-wave travel is performed and when ordinary travel is performed, that is, when green-wave travel control is not performed.

Deceleration starting at a position significantly far from the traffic light position Ps, the maximum deceleration dV being large, the duration of low-speed range DL being long, or the speed deviation ΔV being excessively large may lead to the occupant experiencing unease or discomfort. Therefore, according to the present embodiment, if the vehicle speed pattern in the passing travel plan when the green-wave travel control is performed is expected to cause unease or discomfort in the occupant of the own vehicle V1 or the other vehicle V2 that follows as described above, green-wave travel control is not performed. In this case, according to the present embodiment, vehicle travel control using the stopping travel plan to stop the own vehicle V1 at the traffic light position Ps is performed.

However, in this case, the energy saving effect cannot be achieved by simply not performing the green-wave travel control. Therefore, according to the present embodiment, a vehicle speed pattern that saves as much energy as possible is used when the own vehicle V1 is stopped at the traffic light position Ps using the stopping travel plan. A solid line in FIG. 5 shows an example of such a vehicle speed pattern. Therefore, according to the present embodiment, the desired energy saving effect and environmental performance can be achieved while favorably suppressing unease and discomfort experienced by the occupant.

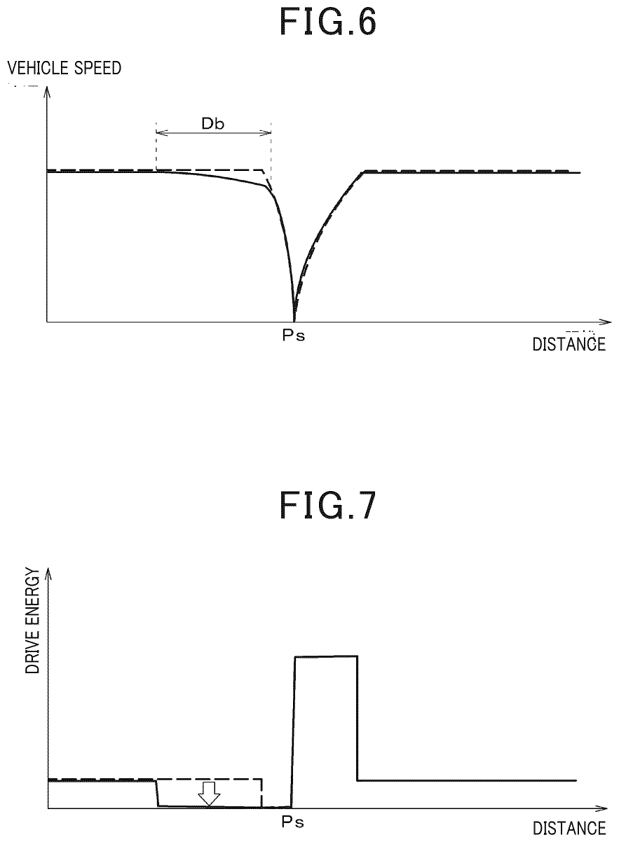

A solid line in FIG. 6 indicates a vehicle speed pattern in a case in which a gradual deceleration period Db using engine braking or coasting is provided in the stopping travel plan. FIG. 7 shows the energy consumption reduction effect of such a vehicle speed pattern. In FIG. 7, a solid line shows the energy consumption reduction effect in the case of the stopping travel plan according to the present embodiment, and a broken line shows the energy consumption reduction effect in a case of an ordinary stop to wait for the light to change (that is, a case in which the energy consumption reduction effect is not taken into consideration). As indicated by a white downward arrow in FIG. 7, according to the present embodiment, energy efficiency when the stopping travel plan is performed can be improved.

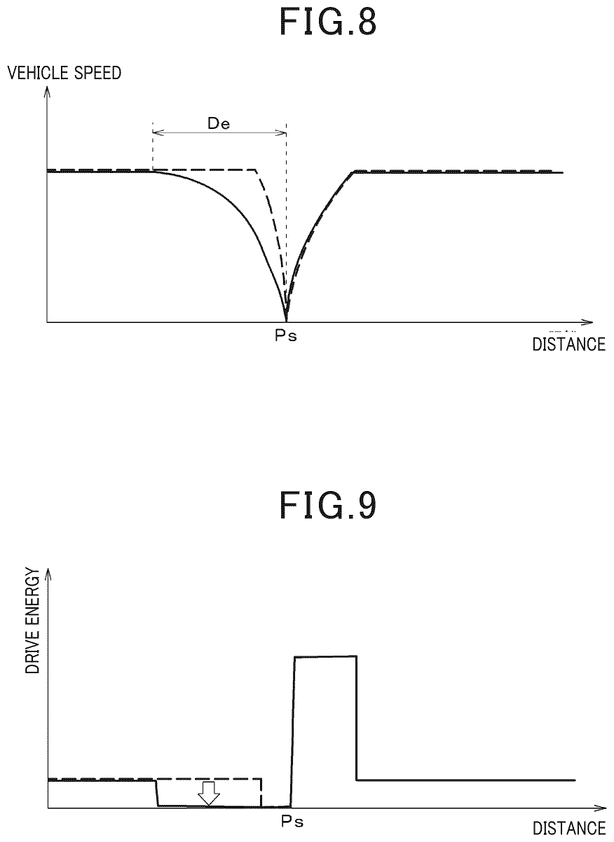

A solid line in FIG. 8 shows a vehicle speed pattern that minimizes energy consumption. Specifically, in FIG. 8, during a deceleration period De, regenerative braking is used in addition to engine braking and coasting. FIG. 9 shows the energy consumption reduction effect of such a vehicle speed pattern. In FIG. 9, a solid line shows the energy consumption reduction effect in the case of the stopping travel plan according to the present embodiment, and a broken line shows the energy consumption reduction effect in the case of an ordinary stop to wait for the light to change. As indicated by a white downward arrow in FIG. 9, according to the present embodiment, energy efficiency when the stopping travel plan is performed can be improved.

### Operational Example

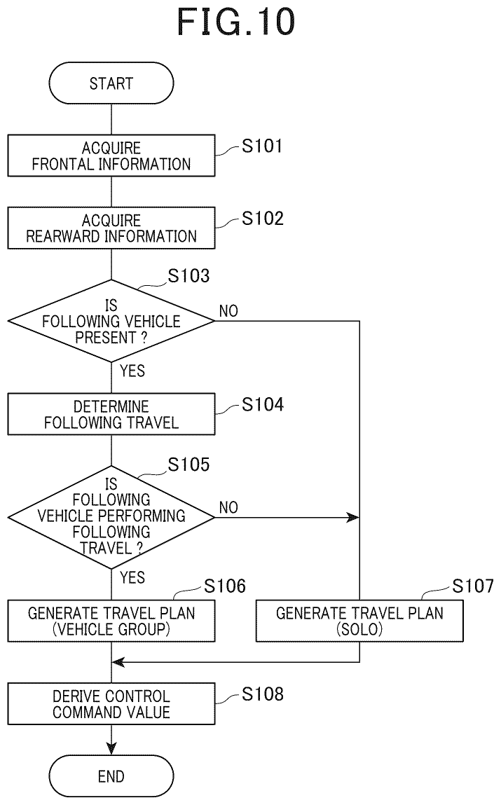

A specific operational example according to the present embodiment will be described below with reference to flowcharts in FIG. 10 to FIG. 12. In the flowcharts, “S” stands for “step.” The processor 71 provided in the travel control apparatus 7 reads out the travel control program according to the present embodiment and various data such as initial values required to run the travel control program from the memory 72. The processor 71 then starts the program and performs each process shown in FIG. 10.

The present operational example gives an example of green-wave travel control in the road section Rc in which a plurality of traffic lights TS are present. However, the present disclosure is not limited to this example. First, at step S101, the processor 71 acquires the frontal information. In addition, at step S102, the processor 71 acquires the rearward information. The process at step S101 and the process at step S102 may be performed in either order. Alternatively, the process at step S101 and the process at step S102 may be performed substantially simultaneously. Next, at step S103, the processor 71 determines whether a following vehicle is present within a predetermined range (that is, within a predetermined distance) behind the own vehicle V1 based on the acquired rearward information.

When determined that a following vehicle is present (that is, YES at step S103), the processor 71 proceeds to step S104 and step S105. At step S104, the processor 71 performs a determination process to determine whether the following vehicle is performing following-travel to follow the own vehicle V1. Following-travel refers to a vehicle traveling in a same direction as a preceding vehicle while controlling the inter-vehicle distance to the preceding vehicle within a predetermined range. For example, following-travel can be performed by so-called inter-vehicle distance control. The inter-vehicle distance control is also referred to as ACC. ACC is an abbreviation of Adaptive Cruise Control. At step S105, the processor 71 determines whether a following vehicle that is performing following-travel to follow the own vehicle V1 is present.

When determined that a following vehicle that is performing following-travel to follow the own vehicle V1 is present (that is, YES at step S105), the processor 71 proceeds to step S106. At step S106, the processor 71 generates a travel plan to perform platoon travel control taking into consideration the energy consumption of not only the own vehicle V1 but also the following vehicle.

When determined that a following vehicle is not present in the first place (that is, NO at step S103) and when determined that a following vehicle is present but not performing following-travel to follow the own vehicle V1 (that is, NO at step S105), the processor 71 proceeds to step S107. At step S107, the processor 71 generates a travel plan under an assumption that the own vehicle V1 is traveling alone.

After performing the process at step S106 or step S107, the processor 71 proceeds to step S108. At step S108, the processor 71 derives the control command value, that is, the control parameter corresponding to the generated travel plan.

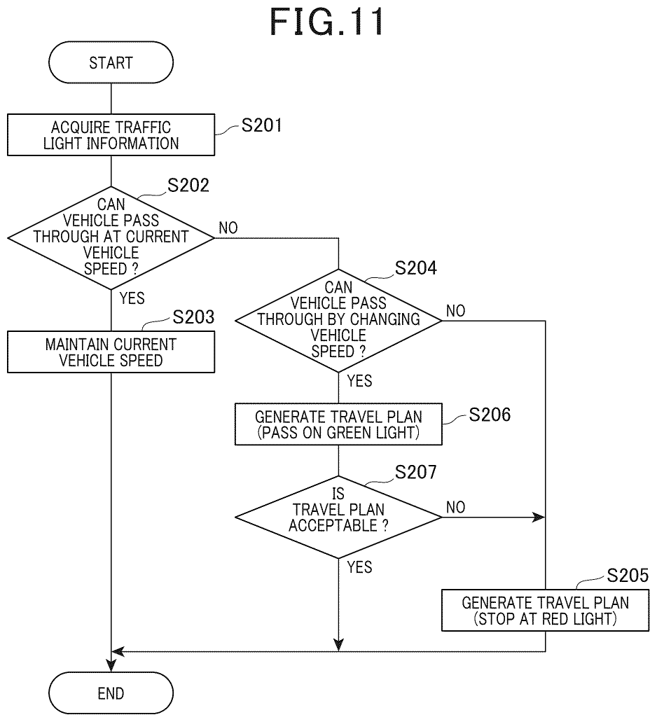

FIG. 11 shows content of the travel plan generation process for solo travel at step S107 shown in FIG. 10. In the travel plan generation process, first, the processor 71 performs processes at step S201 and step S202.

At step S201, the processor 71 acquires the traffic light information including the current lighting states and display cycles of the plurality of traffic lights TS in the road section Rc serving as the green-wave travel control section. At step S202, the processor 71 determines whether the own vehicle V1 can pass through the next traffic light TS at the current vehicle speed.

When determined that the own vehicle V1 can pass through the next traffic light TS at the current vehicle speed (that is, YES at step S202), the processor 71 performs a process at step S203 and then temporarily ends the travel plan generation process. At step S203, the processor 71 maintains the current vehicle speed of the own vehicle V1. Conversely, when determined that the own vehicle V1 cannot pass through the next traffic light TS at the current vehicle speed (that is, NO at step S202), the processor 71 proceeds to step S204.

At step S204, the processor 71 determines whether the own vehicle V1 can pass through the next traffic light TS by changing the vehicle speed of the own vehicle V1. When determined NO at step S204, the processor 71 performs a process at step S205 and then temporarily ends the travel plan generation process. At step S205, the processor 71 determines a stopping travel plan that is a travel plan for stopping the own vehicle V1 at a red light at a stop position corresponding to the next traffic light TS, as the travel plan for vehicle control. As a result, travel control such as that shown in FIG. 6 or FIG. 8 in which improvement in energy efficiency when the own vehicle V1 decelerates and stops to wait for the traffic light to change is performed.

Conversely, when determined YES at step S204, the processor 71 proceeds to step S206 and step S207. At step S206, the processor 71 temporarily determines a passing travel plan that is a travel plan for allowing the own vehicle V1 to pass through the next traffic light TS on a green light by green-wave travel control, as the travel plan for vehicle control. Then, at step S207, the processor 71 determines whether the travel plan temporarily determined at step S206 is acceptable, that is, whether the travel plan will not cause the occupant to experience unease or discomfort.

When determined YES at step S207, the processor 71 maintains the travel plan temporarily determined at step S206 and temporarily ends the travel plan generation process. Conversely, when determined “NO at step S207, the processor 71 performs the process at step S205 and then temporarily ends the travel plan generation process. In this case, at step S205, the processor 71 discards the travel plan temporarily determined at step S206, and determines a stopping travel plan that is a travel plan for stopping the own vehicle V1 at a red light at the stopping position corresponding to the next traffic light TS, as the travel plan for vehicle control.

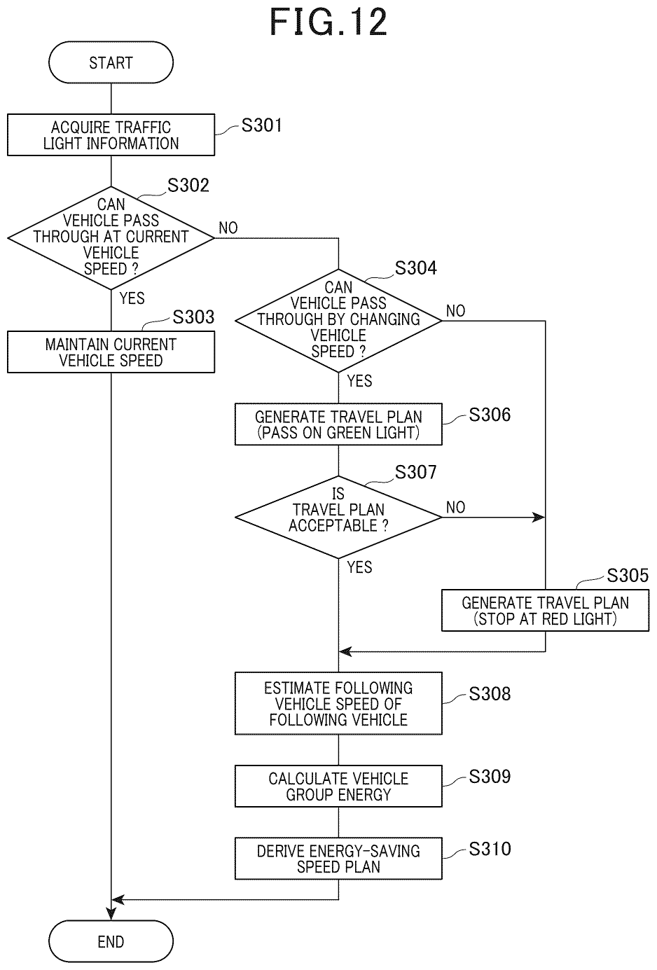

FIG. 12 shows content of the travel plan generation process for platoon travel control at step S106 shown in FIG. 10. Step S301 to step S303 shown in FIG. 12 are similar to step S201 to step S203 shown in FIG. 11. Therefore, processes at step S304 and subsequent steps will be described below.

At step S304, the processor 71 determines whether the own vehicle V1 can pass through the next traffic light TS by changing the vehicle speed of the own vehicle V1.

When determined NO at step S304, the processor 71 proceeds to step S305. At step S305, the processor 71 determines a stopping travel plan that is a travel plan for stopping the own vehicle V1 at a red light at the stop position corresponding to the next traffic light TS, as the travel plan for vehicle control.

Conversely, when determined YES at step S304, the processor 71 proceeds to step S306 and step S307. At step S306, the processor 71 temporarily determines a passing travel plan that is a travel plan for allowing the own vehicle V1 to pass through the next traffic light TS on a green light by green-wave travel control, as the travel plan for vehicle control. Then, at step S307, the processor 71 determines whether the travel plan temporarily determined at step S306 is acceptable, that is, whether the travel plan will not cause the occupant to experience unease or discomfort.

When determined YES at step S307, the processor 71 maintains the travel plan temporarily determined at step S306. Conversely, when determined NO at step S307, the processor 71 proceeds to step S305. In this case, at step S305, the processor 71 discards the travel plan temporarily determined at step S306, and determines a stopping travel plan that is a travel plan for stopping the own vehicle V1 at a red light at the stopping position corresponding to the next traffic light TS, as the travel plan for vehicle control.

After the travel plan is determined at step S305 or step S306, the processor 71 performs processes at step S308 to step S310, and then temporarily ends the travel plan generation process. At step S308, the processor 71 estimates the vehicle speed of the following vehicle. At step S309, the processor 71 performs energy calculations for each vehicle in the vehicle group including the own vehicle V1 and the following vehicle. At step S310, the processor 71 derives a vehicle speed pattern for performing travel control allowing the overall vehicle group to save energy.

As described in detail above, as a result of the present specific example, energy-saving travel of not only the own vehicle V1 but also the overall vehicle group including the own vehicle V1 can be actualized through travel control of only the own vehicle V1 that is the leading vehicle of the vehicle group. In addition, as a result of the present specific example, both the energy saving effect and the suppression of unease and discomfort experienced by the occupant in accompaniment to energy-saving travel can be achieved.

### Modifications

The present disclosure is not limited to the embodiment and specific examples described above. Therefore, the above-described embodiment and the like can be modified as appropriate. Representative modifications will be described below. In the description of modifications below, differences from the above-described embodiment and the like will be mainly described. In addition, sections that are identical or equivalent to each other among the above-described embodiments and the like, and the modifications described below are given the same reference numbers. Therefore, in the description of the modifications below, the description according to the above-described embodiments and the like are applicable as appropriate regarding constituent elements having the same reference numbers as those according to the above-described embodiments and the like, unless technical conflicts arise or additional descriptions are particularly given.

The present disclosure is not limited to the specific apparatus configurations described according to the above-described embodiment. That is, for example, the means or configuration for acquiring the frontal information and the rearward information is not particularly limited.

All or part of the travel control apparatus 7 may be configured to include a digital circuit, such as an ASIC or FPGA, configured to be capable of actualizing the functions or operations described above. ASIC is an abbreviation of Application Specific Integrated Circuit. FPGA is an abbreviation of Field Programmable Gate Array. That is, in the travel control apparatus 7, an in-vehicle microcomputer portion and a digital circuit portion can both be present.

A computer program of the present disclosure that enables the various operations, procedures, or processes described according to the above-described embodiment to be performed can be downloaded or upgraded through V2X communication using the communication apparatus 6. Alternatively, the computer program can be downloaded or upgraded through a terminal apparatus provided at a manufacturing plant, a repair shop, a dealer, or the like, of the own vehicle V1. The computer program may be stored on a memory card, an optical disc, a magnetic disk, or the like.

In this manner, the functional configurations and processes described above may be actualized by a dedicated computer that is provided such as to be configured by the processor 71 and the memory 72, the processor 71 being programmed to provide one or a plurality of functions that are realized by a computer program. Alternatively, the functional configurations and processes described above may be actualized by a dedicated computer that is provided by the processor 71 being configured by one or more dedicated hardware logic circuits. Still alternatively, the functional configurations and processes described above may be actualized by one or more dedicated computers. The dedicated computer may be configured by a combination of one or more processors 71 that are programmed to provide one or a plurality of functions, one or more memories 72, and one or more other processors 71 that is configured by one or more hardware logic circuits. In addition, the computer program may be stored in a non-transitory computer-readable storage medium that can be read by a computer as instructions performed by the computer. That is, the functional configurations and processes described above can also be expressed as a computer program including steps to actualize the functional configurations and processes described above, or a non-transitory computer-readable storage medium storing the computer program therein.

All or a part of the functional configurations shown in FIG. 3 that are included in the travel control apparatus 7 may be provided in the movement control apparatus 8. Alternatively, the travel control apparatus 7 and the movement control apparatus 8 may be integrated.

The present disclosure is not limited to the specific operational example described according to the above-described embodiment. That is, for example, as described above, the green-wave travel control is not limited to travel control in the road section Rc in which a plurality of traffic lights TS are set and can be performed even when only a single traffic light TS is present. In addition, the “green light” in green-wave travel may include a state that is “red light+green arrow.” Furthermore, the present disclosure is not limited to when the own vehicle V1 is the leading vehicle in platoon travel. Moreover, the following vehicle that is performing following-travel in the present disclosure is not limited to that performing ACC and includes following vehicles that are being manually driven (that is, SAE level 0).

When a plurality of travel plans capable of favorably suppressing unease and discomfort experienced by the occupant can be selected, the energy-saving planning unit 753 may select the travel plan that maximizes energy efficiency or may select the travel plan taking into consideration a balance between occupant comfort and energy efficiency.

The energy-saving planning unit 753 may correct the vehicle speed control information included in the travel plan generated by the travel plan generation unit 702 from the perspective of improving energy efficiency. In this case, the travel plan generation unit 702 may generate only either of the passing travel plan and the stopping travel plan.

It goes without saying that an element that configures the above-described embodiment is not necessarily a requisite unless particularly specified as being a requisite, clearly considered a requisite in principle, or the like. In addition, in cases in which a numeric value, such as quantity, numeric value, amount, or range, of a constituent element is mentioned, the present disclosure is not limited to the specific number unless particularly specified as being a requisite, clearly limited to the specific number in principle, or the like. In a similar manner, in cases in which a shape, direction, positional relationship, or the like of a constituent element or the like is mentioned, the present disclosure is not limited to the shape, direction, positional relationship, or the like unless particularly specified as being a requisite, clearly limited to the specific shape, direction, positional relationship, or the like in principle, or the like.

Similar expressions such as “acquire,” “calculate,” “estimate,” “detect,” and “sense” are interchangeable as long as technical conflicts do not occur. In addition, “exceeds a threshold” and “equal to or greater than a threshold” are interchangeable as long as technical conflicts do not occur. This similarly applies to “below a threshold” and “equal to or less than a threshold.”

Modifications are also not limited to the examples given above. For example, one of the plurality of modifications may be combined, in its entirety or in part, with another in its entirety or in part as long as technical conflicts do not occur. Moreover, the above-described specific example may be combined, in its entirety or in part, with an above-described modification in its entirety or in part as long as technical conflicts do not occur.

### OTHER ASPECTS

Characteristics of the present disclosure are as follows:

### First Aspect

A travel control apparatus (7) for a vehicle, the travel control apparatus including: at least one of (i) a circuit and (ii) a processor with a memory storing computer program code executable by the processor, the at least one of the circuit and the processor configured to implement: a frontal information acquisition unit (701) that acquires frontal information including a display cycle of one or more traffic lights (TS) ahead of the vehicle; a travel plan generation unit (702) that generates a passing travel plan in which the vehicle passes through the traffic light without needing to wait for the traffic light to change, based on the acquired frontal information; and a travel plan determination unit (752) that determines that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, in which the stopping travel recommendation condition includes a vehicle speed equal to or less than a threshold vehicle speed continuing for a predetermined period of time or longer, or deceleration exceeding a deceleration threshold.

### Second Aspect

The travel control apparatus according to the first aspect, further including: an energy-saving planning unit (753) that determines the vehicle speed control information included in the passing travel plan or the stopping travel plan from a perspective of improving energy efficiency.

### Third Aspect

The travel control apparatus according to the first aspect, further including: an energy-saving planning unit (753) that determines the vehicle speed control information included in the passing travel plan or the stopping travel plan from a perspective of improving energy efficiency.

### Fourth Aspect

The travel control apparatus according to the second or third aspect, further including: a rearward information acquisition unit (703) that acquires rearward information including presence/absence of a following vehicle performing following-travel behind the vehicle, in which the energy-saving planning unit determines the vehicle speed control information to maximize energy efficiency in a vehicle group including the vehicle and the following vehicle.

### Fifth Aspect

A travel control method for a vehicle, the travel control method including: acquiring frontal information including a display cycle of one or more traffic lights (TS) ahead of the vehicle; generating a passing travel plan in which the vehicle passes through the traffic light without needing to wait for the traffic light to change, based on the acquired frontal information; and determining that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, in which the stopping travel recommendation condition includes a vehicle speed equal to or less than a threshold vehicle speed continuing for a predetermined period of time or longer, or deceleration exceeding a deceleration threshold.

### Sixth Aspect

A non-transitory computer-readable storage medium storing therein a travel control program executed by a computer of a travel control apparatus (7) for a vehicle, the travel control program causing, when executed by the computer, the travel control apparatus to perform processes including: a process for acquiring frontal information including a display cycle of one or more traffic lights (TS) ahead of the vehicle; a process for generating a passing travel plan in which the vehicle passes through the traffic light without needing to wait for the traffic light to change, based on the acquired frontal information; a process for determining that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, in which the stopping travel recommendation condition includes a vehicle speed equal to or less than a threshold vehicle speed continuing for a predetermined period of time or longer, or deceleration exceeding a deceleration threshold.

### Seventh Aspect

A computer program product including a travel control program executed by a computer of a travel control apparatus (7) for a vehicle, the travel control program causing, when executed by the computer, the travel control apparatus to perform processes including: a process for acquiring frontal information including a display cycle of one or more traffic lights (TS) ahead of the vehicle; a process for generating a passing travel plan in which the vehicle passes through the traffic light without needing to wait for the traffic light to change, based on the acquired frontal information; a process for determining that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, in which the stopping travel recommendation condition includes a vehicle speed equal to or less than a threshold vehicle speed continuing for a predetermined period of time or longer, or deceleration exceeding a deceleration threshold.

What is claimed is:

1. A travel control apparatus for a vehicle, the travel control apparatus comprising:
at least one of (i) a circuit and (ii) a processor with a memory storing computer program code executable by the processor, the at least one of the circuit and the processor configured to implement:
a frontal information acquisition unit that acquires frontal information including a display cycle of one or more traffic lights ahead of the vehicle;
a travel plan generation unit that generates a passing travel plan in which the vehicle passes through the traffic light without needing to wait for the traffic light to change, based on the acquired frontal information; and
a travel plan determination unit that determines that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, wherein
the stopping travel recommendation condition includes a vehicle speed equal to or less than a threshold vehicle speed continuing for a predetermined period of time or longer, or deceleration exceeding a deceleration threshold.

2. The travel control apparatus according to claim 1, further comprising:
an energy-saving planning unit that determines the vehicle speed control information included in the passing travel plan or the stopping travel plan from a perspective of improving energy efficiency.

3. The travel control apparatus according to claim 2, wherein:
the energy-saving planning unit determines the vehicle speed control information included in the stopping travel plan from a perspective of improving energy efficiency when decelerating and stopping to wait for the traffic light to change.

4. The travel control apparatus according to claim 2, further comprising:
a rearward information acquisition unit that acquires rearward information including presence/absence of a following vehicle performing following-travel behind the vehicle, wherein
the energy-saving planning unit determines the vehicle speed control information to maximize energy efficiency in a vehicle group including the vehicle and the following vehicle.

5. The travel control apparatus according to claim 3, further comprising:
a rearward information acquisition unit that acquires rearward information including presence/absence of a following vehicle performing following-travel behind the vehicle, wherein
the energy-saving planning unit determines the vehicle speed control information to maximize energy efficiency in a vehicle group including the vehicle and the following vehicle.

6. A travel control method for a vehicle, the travel control method comprising:
acquiring frontal information including a display cycle of one or more traffic lights ahead of the vehicle;
generating a passing travel plan in which the vehicle passes through the traffic light without needing to wait for the traffic light to change, based on the acquired frontal information; and
determining that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, wherein
the stopping travel recommendation condition includes a vehicle speed equal to or less than a threshold vehicle speed continuing for a predetermined period of time or longer, or deceleration exceeding a deceleration threshold.

7. A non-transitory computer-readable storage medium storing therein a travel control program executed by a computer of a travel control apparatus for a vehicle, the travel control program causing, when executed by the computer, the travel control apparatus to perform processes comprising:
a process for acquiring frontal information including a display cycle of one or more traffic lights ahead of the vehicle;
a process for generating a passing travel plan in which the vehicle passes through the traffic light without needing to wait for the traffic light to change, based on the acquired frontal information;
a process for determining that travel control of the vehicle is performed using a stopping travel plan in which the vehicle is stopped at the traffic light to wait for the traffic light to change, instead of the passing travel plan, in response to vehicle speed control information included in the generated passing travel plan including a predetermined stopping travel recommendation condition, wherein
the stopping travel recommendation condition includes a vehicle speed equal to or less than a threshold vehicle speed continuing for a predetermined period of time or longer, or deceleration exceeding a deceleration threshold.
